(19) United States
(12) Patent Application Publication
(10) Pub. No.: US 2025/0229838 A1
(43) Pub. Date: Jul. 17, 2025

(54) VEHICLE BODY PILLAR STRUCTURE AND VEHICLE BODY SIDE STRUCTURE

(71) Applicant: SUBARU CORPORATION, Tokyo (JP)

(72) Inventor: Hiroyasu ITO, Tokyo (JP)

(73) Assignee: SUBARU CORPORATION, Tokyo (JP)

(21) Appl. No.: 19/169,530

(22) Filed: Apr. 3, 2025

Related U.S. Application Data
(63) Continuation of application No. PCT/JP2023/033653, filed on Sep. 15, 2023.

(51) Int. Cl. B62D 25/04; B62D 25/02

(52) U.S. Cl. CPC B62D 25/04; B62D 25/025

(57) ABSTRACT

A vehicle body pillar structure uses a fiber-reinforced resin composite material. The vehicle body pillar structure includes two tubular portions made of a fiber-reinforced resin and arranged side by side in a vehicle body front-rear direction of a vehicle. Each of the two tubular portions extends in a direction of an axis along a vehicle body height direction of the vehicle. The vehicle body pillar structure has a first region and a second region. In the first region, the two tubular portions are joined to each other on an upper side in the vehicle body height direction. In the second region, the two tubular portions diverge and are spaced apart from each other on a lower side in the vehicle body height direction. Each of the two tubular portions includes a metal plate provided over the first region and the second region.

### CROSS REFERENCE TO RELATED APPLICATIONS

This application is continuation of International Application No. PCT/JP2023/033653, filed on Sep. 15, 2023, the entire contents of which are hereby incorporated by reference.

### BACKGROUND

The technology of the present disclosure relates to a vehicle body pillar structure and a vehicle body side structure using a fiber-reinforced resin composite material.

In recent years, for the purpose of reducing the weight of a vehicle body of a vehicle such as a passenger car, it has been studied to manufacture a vehicle body structure by using a fiber reinforced resin represented by a carbon fiber reinforced resin (hereinafter, referred to as CFRP). The member made of fiber-reinforced resin has high rigidity and exhibits high strength particularly against compressive stress or tensile stress acting along the orientation direction of the fibers. For example, Japanese Unexamined Patent Application Publication Nos. 2019-182168 and 2015-47895 disclose a center pillar in which a fiber-reinforced resin composite material is used as a part of a constituent member.

### SUMMARY

An aspect of the disclosure provides a vehicle body pillar structure using a fiber-reinforced resin composite material. The vehicle body pillar structure includes two tubular portions made of a fiber-reinforced resin and arranged side by side in a vehicle body front-rear direction of the vehicle. Each of the two tubular portions extends in a direction of an axis along a vehicle body height direction of the vehicle. The vehicle body pillar structure has a first region and a second region. In the first region, the two tubular portions are joined to each other on an upper side in the vehicle body height direction. In the second region, the two tubular portions diverge and are spaced apart from each other on a lower side in the vehicle body height direction. Each of the two tubular portions includes a metal plate provided over the first region and the second region.

An aspect of the disclosure provides a vehicle body pillar structure using a fiber-reinforced resin composite material. The vehicle body pillar structure includes two tubular portions made of a fiber-reinforced resin and arranged side by side in a vehicle body front-rear direction of the vehicle. Each of the two tubular portions extends in a direction of an axis along a vehicle body height direction of the vehicle. The vehicle body pillar structure has a first region and a second region. In the first region, the two tubular portions are joined to each other on an upper side in the vehicle body height direction. In the second region, the two tubular portions diverge and are spaced apart from each other on a lower side in the vehicle body height direction. The vehicle body pillar structure further includes, in the first region, a first winding layer and a second winding layer including a continuous fiber wound around the two tubular portions and around the axis. The first winding layer is provided from the first region to a first tubular portion of the two tubular portions in the second region. The second winding layer is provided from the first region to a second tubular portion of the two tubular portions other than the first tubular portion in the second region.

An aspect of the disclosure provides a vehicle body side structure using a fiber-reinforced resin composite material. The vehicle body side structure includes a center pillar and a side sill. The center pillar includes two tubular portions made of a fiber-reinforced resin and arranged side by side in a vehicle body front-rear direction of a vehicle, each of the two tubular portions extending in a direction of an axis along a vehicle body height direction of the vehicle. The center pillar has a first region and a second region. In the first region, the two tubular portions are joined to each other on an upper side in the vehicle body height direction. In the second region, the two tubular portions diverge and are spaced apart from each other on a lower side in the vehicle body height direction. The side sill is disposed along the vehicle body front-rear direction and coupled to a lower portion of the center pillar. A belt retractor is disposed in a space between the two tubular portions in the second region. Each of the two tubular portions includes a metal plate provided over the first region and the second region.

An aspect of the disclosure provides a vehicle body side structure using a fiber-reinforced resin composite material. The vehicle body side structure includes a center pillar and a side sill. The center pillar includes two tubular portions made of a fiber-reinforced resin and arranged side by side in a vehicle body front-rear direction of a vehicle. Each of the two tubular portions extends in a direction of an axis along a vehicle body height direction of the vehicle. The two tubular portions have a first region and a second region. In the first region, the two tubular portions are joined to each other on an upper side in the vehicle body height direction. In the second region, the two tubular portions diverge and are spaced apart from each other on a lower side in the vehicle body height direction. The side sill is disposed along the vehicle body front-rear direction and coupled to a lower portion of the center pillar. A belt retractor is disposed in a space between the two tubular portions in the second region. The vehicle body side structure further includes, in the first region, a first winding layer and a second winding layer. The first winding layer and the second winding layer each include a continuous fiber wound around the two tubular portions and around the axis. The first winding layer is provided from the first region to a first tubular portion of the two tubular portions in the second region.

The second winding layer is provided from the first region to a second tubular portion of the two tubular portions other than the first tubular portion in the second region.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a schematic view illustrating an overall configuration of a vehicle body side structure according to an embodiment of the disclosure.

FIG. 2 is an explanatory view illustrating a center pillar according to the embodiment.

FIG. 3 is an explanatory view illustrating a pillar structure portion of the center pillar according to the embodiment.

FIG. 4 is an explanatory view illustrating an end surface of a I-I cross section of the pillar structure portion illustrated in FIG. 3.

FIG. 5 is an explanatory view illustrating an end surface of a II-II cross section of the pillar structure portion illustrated in FIG. 3.

FIG. 6 is an explanatory view illustrating a connecting structure between the pillar structure portion and a side sill according to the embodiment.

FIG. 7 is an explanatory view illustrating a method of manufacturing the pillar structure portion of the center pillar according to the embodiment.

FIG. 8 is an explanatory view illustrating a method of manufacturing the pillar structure portion of the center pillar according to the embodiment.

FIG. 9 is an explanatory view illustrating a method of manufacturing the pillar structure portion of the center pillar according to the embodiment.

### DETAILED DESCRIPTION

Even in a case in which a pillar is structured with a fiber-reinforced resin composite material as a main member, a function equivalent to that of a conventional metal pillar is desired. For example, in the case of a center pillar, at the time of a side collision of the vehicle, an upper portion of the center pillar is to be suppressed from bending in order to protect the head of an occupant, and a lower portion of the center pillar is to absorb energy by deformation. In this case, when the strength of the center pillar is considered, it is desirable that the center pillar is continuously formed from the upper portion to the lower portion without providing a joint portion in the middle in the vehicle body height direction.

In addition, when a load is input to the center pillar at the time of a side collision, torsion occurs at the connecting portion between the center pillar and the side sill. At this time, if stresses are concentrated on the connecting portion, the fiber-reinforced resin-made center pillar may break and bend toward the vehicle cabin side.

It is desirable to provide a vehicle body pillar structure and a vehicle body side structure that are made of a fiber-reinforced resin composite material and can suppress a decrease in the strength of a pillar when the pillar of a vehicle body is formed using the fiber-reinforced resin composite material.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

First, an outline of a vehicle body side structure according to the embodiment will be described.

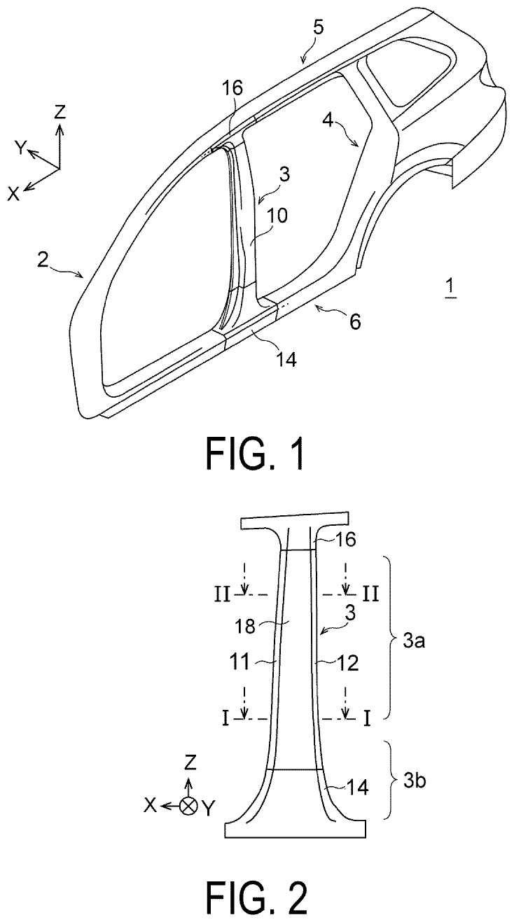

FIG. 1 is a schematic view illustrating an appearance of a vehicle body side structure 1. The vehicle body side structure 1 illustrated in FIG. 1 schematically illustrates a part of a structure of a left side portion of a vehicle. FIG. 2 is a side view of a center pillar 3 as viewed from the outside in the vehicle width direction. As illustrated in FIGS. 1 and 2, in the present specification, a front-rear direction of a vehicle body is referred to as an X direction, a vehicle width direction is referred to as a Y direction, and a height direction of the vehicle body is referred to as a Z direction.

The vehicle body side structure 1 is constituted by a roof rail 5, a rear pillar 4, a front pillar 2, the center pillar 3, a side sill 6, and the like. The roof rail 5 extends along the vehicle body front-rear direction in an upper portion of a vehicle cabin space of the vehicle, and forms a side portion of a roof of the vehicle. The side sill 6 extends along the vehicle body front-rear direction at a lower portion of a side portion of the vehicle.

A lower end of the front pillar 2 is coupled to a front end of the side sill 6, and an upper end of the front pillar 2 is coupled to a front end of the roof rail 5. The front pillar 2 forms a front portion constituting a cabin space of the vehicle, and is disposed so as to support a side of a windshield. A lower end of the rear pillar 4 is coupled to a rear end of the side sill 6, and an upper end of the rear pillar 4 is coupled to a rear end of the roof rail 5. A lower end of the center pillar 3 is coupled to a central portion of the side sill 6 in the vehicle body front-rear direction, and an upper end of the center pillar 3 is coupled to a central portion of the roof rail 5 in the vehicle body front-rear direction. In the present embodiment, the center pillar 3 corresponds to one form of a vehicle body pillar structure of the present disclosure.

An opening for a front door is formed between the side sill 6, the roof rail 5, the front pillar 2, and the center pillar 3. An opening for a rear door is formed between the side sill 6, the roof rail 5, the rear pillar 4, and the center pillar 3. Each member constituting the vehicle body side structure 1 may be constituted by members.

In the vehicle body side structure 1, the center pillar 3 has a longitudinal direction along the height direction and is formed in a columnar shape. A first connecting member 14 for covering a connecting portion with the side sill 6 is provided at a lower end of the center pillar 3, and a second connecting member 16 for covering a connecting portion with the roof rail 5 is provided at an upper end of the center pillar 3.

The center pillar 3 is configured as, for example, a structure in which a pillar structural member is sandwiched between and joined to an outer panel 18 disposed on the outer side in the vehicle widthwise direction and an inner panel (not illustrated) disposed on the cabin side. The center pillar 3 has flanges 11, 12 on each of the side surfaces on the vehicle body front side and the vehicle body rear side. The flanges 11, 12 are used as, for example, a door stop of a door. A method of forming the flanges 11, 12 on the center pillar 3 is not particularly limited. The flanges 11, 12 formed as a separate member may be joined to the center pillar 3, or the flanges 11, 12 may be provided on one or both of the outer panel 18 and an inner panel (not illustrated) which are exterior materials.

A first region 3a of the upper portion of the center pillar 3, which includes at least a range corresponding to the height of the head of the occupant, functions to suppress breakage of the center pillar 3 and protect the head of the occupant in the vehicle side collision. On the other hand, a second region 3b including the range corresponding to the height of the bumper of the passenger car in the lower portion of the center pillar 3 functions to absorb the collision energy input at the time of the side collision of the car and to mitigate the impact to the inside of the car room or the like. The second region 3b corresponds to an energy absorbing region.

Next, the configuration of the center pillar 3 as the vehicle body pillar structure according to the present embodiment will be described in detail.

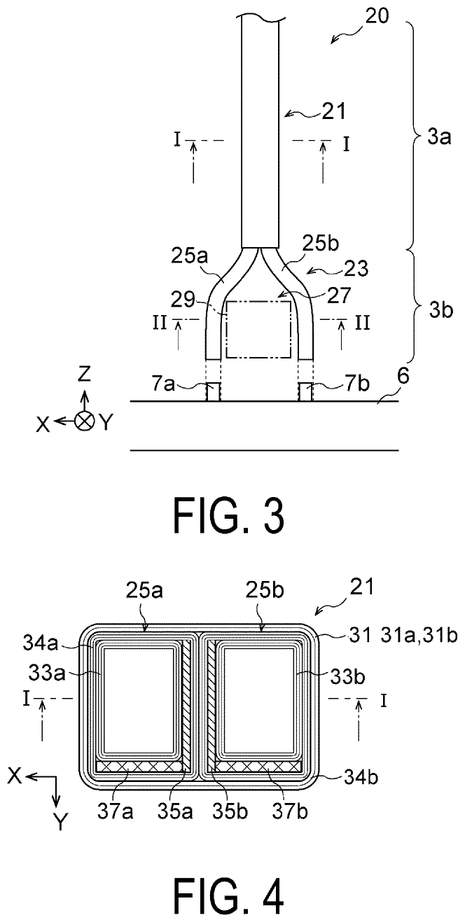

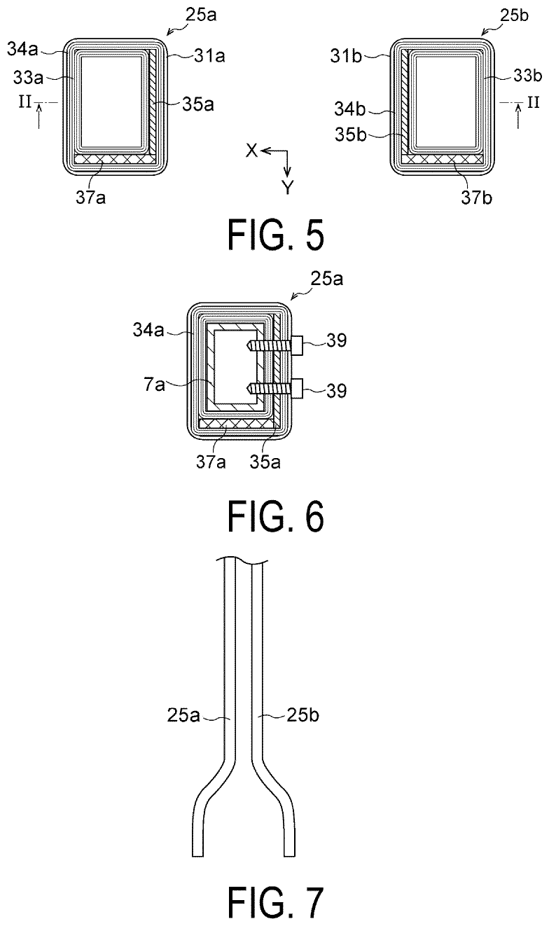

FIGS. 3 to 6 are views for explaining the configuration of the center pillar 3. FIG. 3 is a perspective view of a part of a pillar structure portion 21 including the connecting portion between the center pillar 3 and the side sill 6. FIG. 4 is a cross-sectional end view of the pillar structure portion 21 taken along line I-I of FIG. 3, and FIG. 5 is a cross-sectional end view of the pillar structure portion 21 taken along line II-II of FIG. 3. FIG. 6 illustrates a cross-sectional view of the connecting portion between the pillar structure portion 21 and the side sill 6.

In each of the illustrated pillar structure portions 21, the first connecting member 14, the second connecting member 16, and the outer panel 18 are omitted from the center pillar 3 illustrated in FIG. 2. In each of the drawings, a front-rear direction (X direction) of a vehicle body, a vehicle width direction (Y direction), and a height direction (Z direction) of the vehicle body are illustrated.

The pillar structure portion 10 includes a first tubular portion 25a and a second tubular portion 25b. The first tubular portion 25a and the second tubular portion 25b are each a tubular portion made of a fiber-reinforced resin composite material extending in the direction of an axis along the Z direction, and are arranged side by side in the X direction. The first tubular portion 25a and the second tubular portion 25b are joined to each other on the upper side in the Z direction. On the other hand, on the lower side in the Z direction, the second tubular portion 25b is branched and separated.

Each of the first tubular portion 25a and the second tubular portion 25b is provided continuously from the upper end to the lower end of the pillar structure portion 21 along the Z direction. Each of the first tubular portion 25a and the second tubular portion 25b is made of a fiber-reinforced resin composite material, and includes continuous fibers oriented at angles of 0 degrees and ±45 degrees with respect to the Z direction, for example. The pillar structure portion 21 may include three or more tubular portions as long as the pillar structure portion 21 includes the first tubular portion 25a and the second tubular portion 25b arranged in the X direction.

Each of the first tubular portion 25a and the second tubular portion 25b includes an inner tubular portion 33a (33b), an outer tubular portion 34a (34b), a metal plate 35a (35b), and a reinforcing layer 37a (37b). The inner tubular portion 33a is a radially inner portion of the first tubular portion 25a, and the outer tubular portion 34a is a radially outer portion of the first tubular portion 25a. The inner tubular portion 33b is a radially inner portion of the second tubular portion 25b, and the outer tubular portion 34b is a radially outer portion of the second tubular portion 25b.

The metal plates 35a and 35b are made of a metal material such as aluminum or steel, for example, and are plate-shaped metal materials extending along the Z direction and the Y direction. In particular, when the metal plates 35a and 35b are aluminum plates, it is possible to contribute to the weight reduction of the pillar structure portion 21.

The metal plates 35a and 35b are provided over the first region 3a and the second region 3b, respectively. In the first tubular portion 25a, the metal plate 35a is disposed between the inner tubular portion 33a and the outer tubular portion 34a which constitute a wall surface on the side of the second tubular portion 25b. In the second tubular portion 25b, the metal plate 35b is disposed between the inner tubular portion 33b and the outer tubular portion 34b constituting the wall surface on the side of the first tubular portion 25a.

Since the metal plates 35a and 35b are provided so as to extend in the Y direction and the Z direction, the strength against the load input in the Y direction is increased as compared with the case where the metal plates are provided so as to extend in the X direction and the Z direction. Since the fracture strain of the metal plates 35a and 35b is larger than the fracture strain of the fiber-reinforced resin member, the center pillar 3 can be plastically deformed even when the center pillar 3 is made of the fiber-reinforced resin composite material. Therefore, the strength against the input collision load is increased, and the breakage of the center pillar 3 can be suppressed.

The reinforcing layers 37a and 37b are provided over the first region 3a and the second region 3b, respectively. The reinforcing layers 37a and 37b are disposed between the inner tubular portion 33a and the outer tubular portion 34a that constitute the wall surfaces of the first tubular portion 25a and the second tubular portion 25b on the vehicle cabin side. The reinforcing layers 37a and 37b are disposed so as to extend to positions at which the end portions of the metal plates 35a and 35b are shielded from the vehicle cabin.

For example, the reinforcing layers 37a and 37b are formed of a fiber-reinforced resin composite material containing continuous fibers oriented in a direction intersecting at least the Z direction. Since the reinforcing layers 37a and 37b include the continuous fibers oriented in the direction intersecting the Z direction, the reinforcing layers serve to prevent the metal plates 35a and 35b from jumping out of the center pillar 3 when a load is applied to the center pillar 3 at the time of a side collision.

However, the reinforcing layers 37a and 37b may be formed of a material other than the fiber-reinforced resin composite material as long as the reinforcing layers have a strength capable of receiving the end portions of the metal plates 35a and 35b. For example, the reinforcing layers 37a and 37b may be sheets made of a rubber composite material having desired resilience and strength.

In the first tubular portion 25a and the second tubular portion 25b, the metal plates 35a and 35b and the reinforcing layers 37a and 37b are clearly distinguished on the arranged wall surface, but may be integrated on other wall surfaces.

As illustrated in FIG. 4, the pillar structure portion 21 includes, in the first region 3a, a winding layer 31 including continuous fibers that are wound around the first tubular portion 25a and the second tubular portion 25b that are joined to each other and around the axis. The winding layer 31 has a double structure including a first winding layer 31a on the radially inner side and a second winding layer 31b on the radially outer side. The winding layer 31 has a function of integrally holding the pillar structure portion 21. In the second region 3b, the first tubular portion 25a includes the first winding layer 31a wound around the first tubular portion 25a and around the axis, and the second tubular portion 25b includes the second winding layer 31b wound around the second tubular portion 25b and around the axis.

That is, the first winding layer 31a is provided from the first region 3a to the first tubular portion 25a of the second region 3b. The second winding layer 31b extends from the first region 3a to the second tubular portion 25b in the second region 3b. For example, the first winding layer 31a and the second winding layer 31b each include continuous fibers oriented along directions at angles of 0 degrees and ±45 degrees with respect to the Z direction.

In the first region 3a, the winding layer 31 has a double structure including the first winding layer 31a and the second winding layer 31b, and the winding layer 31 in the first region 3a is formed thicker than each of the first winding layer 31a of the first tubular portion 25a and the second winding layer 31b of the second tubular portion 25b in the second region 3b. In the first region 3a, the winding layer 31 is provided at least up to a region corresponding to the window shoulder portion of the side window. In the present embodiment, the winding layer 31 is provided up to the upper end portion of the pillar structure portion 21.

The first winding layer 31a and second winding layer 31b are clearly distinguished from each other in second region 3b, but may be integrated in first region 3a.

End portions of the first tubular portion 25a and the second tubular portion 25b on the second region 3b side are fitted to fitting portions 7a and 7b provided in the side sill 6, respectively (see FIG. 3). The metal plates 35a and 35b provided on the first tubular portion 25a and the second tubular portion 25b are fastened to the fitting portions 7a and 7b, respectively, using fastening members 39 (see FIG. 6). The number of fastening members 39 used is not particularly limited.

The first tubular portion 25a, the second tubular portion 25b, the first winding layer 31a, the second winding layer 31b, and the reinforcing layers 37a and 37b are formed using, for example, fiber-reinforced resins in which carbon fibers are impregnated with thermoplastic resins or thermosetting resins as matrix resins.

When the matrix resin is a thermoplastic resin, the main material thereof may be, for example, any one or a mixture of two or more of polyethylene resin, polypropylene resin, polyvinyl chloride resin, ABS resin (acrylonitrile-butadiene-styrene copolymer synthetic resin), polystyrene resin, AS resin (acrylonitrile-styrene copolymer synthetic resin), polyamide resin, polyacetal resin, polycarbonate resin, polyester resin, PPS (polyphenylene sulfide) resin, fluororesin, polyetherimide resin, polyether ketone resin, and polyimide resin. Alternatively, the thermoplastic resin may be a copolymer of the above resins. When a mixture of these thermoplastic resins is used as the matrix resin, a compatibilizer may be further added. Further, a bromine-based flame retardant, a silicon-based flame retardant, red phosphorus, or the like may be added to the thermoplastic resin as a flame retardant.

When the matrix resins are heat-curable resins, the main materials thereof may be, for example, any one of epoxy resin, unsaturated polyester resins, vinyl ester resins, phenol resins, polyurethane resins, and silicone resins, or a mixture of two or more thereof. Further, an appropriate curing agent or reaction accelerator may be added to the thermosetting resin.

The carbon fibers may include continuous fibers (axial fibers) oriented in the Z direction and continuous fibers (cross fibers) oriented in a direction intersecting the Z direction at an appropriate ratio. The tensile stress generated by the load input at the time of side collision can be adjusted by the fiber amount of the axial fibers. The stiffness against the input load at the time of a side collision is adjusted by the fiber amount of the cross fibers, and the energy absorption amount can be adjusted. Further, the carbon fibers may contain short fibers in addition to the continuous fibers, and may contain fibers other than the carbon fibers as reinforcing fibers.

Since each of the first region 3a and the second region 3b formed by the first tubular portion 25a and the second tubular portion 25b is a molded body having a tubular shape with a closed cross section, it is possible to maintain the continuity of the fibers not only in the direction of the axis (Z direction) but also in the circumferential direction that is around the axis. Therefore, it is possible to increase rigidity against an input load at the time of a side collision.

The first connecting member 14 and the second connecting member 16 cover the lower end and the upper end of the center pillar 3, respectively, and have a function of connecting the center pillar 3 to the side sill 6 and the roof rail 5. The first connecting member 14 and the second connecting member 16 may be molded products made of, for example, a metal material, but may be molded products made of other materials.

In the center pillar 3 including the pillar structure portion 21 configured as described above, the layer thickness of the winding layer 31 in the first region 3a is larger than the layer thickness of each of the first winding layer 31a of the first tubular portion 25a and the second winding layer 31b of the second tubular portion 25b in the second region 3b. The first region 3a is an area for protecting the head of the occupant by suppressing the bending of the center pillar 3. The layer thickness of the wall portion constituting the center pillar 3 in the first region 3a is relatively thick, and the rigidity of the center pillar 3 in the first region 3a is increased. Thus, the input load can be received by the entirety of the first tubular portion 25a and the second tubular portion 25b, and the center pillar 3 can be prevented from being broken in the first region 3a.

On the other hand, the second region 3b is desirable to absorb a collision load input at the time of a side collision and to mitigate an impact on the vehicle interior or the like. The layer thickness of the wall portion constituting the first tubular portion 25a and the second tubular portion 25b in the second region 3b is relatively thin, and the rigidity of the center pillar 3 in the second region 3b is relatively low. Therefore, in the second region 3b, the deformation of the center pillar 3 due to the load input from the outer side of the center pillar 3 in the vehicle-width direction at the time of the side collision can be concentrated on the second region 3b, and the collision energy can be efficiently absorbed.

In addition, since the first tubular portion 25a and the second tubular portion 25b have the metal plates 35a and 35b extending in the direction of the axis, respectively, it is possible to suppress breakage due to an input load. Further, since the first tubular portion 25a and the second tubular portion 25b respectively include the reinforcing layer 37a and 37b, the load can be received by each of the first tubular portion 25a and the second tubular portion 25b, and the center pillar 3 can be prevented from entering the vehicle interior.

Further, lower end portions of the first tubular portion 25a and the second tubular portion 25b are fitted to tubular fitting portions 7a and 7b provided in the side sill 6, respectively, and are fastened by a fastening member 39 using metal plates 35a and 35b. Therefore, the connection strength between the pillar structure portion 21 and the side sill 6 is increased. Further, it is possible to disperse stresses against torsion generated at the connecting portion between the center pillar 3 and the side sill 6 due to an input load at the time of a side collision. Therefore, the center pillar 3 can be prevented from falling toward the passenger compartment.

The first tubular portion 25a and the second tubular portion 25b are formed continuously from the upper portion to the lower portion in the longitudinal direction of the center pillar 3.

For this reason, structural continuity in the entire longitudinal direction of the center pillar 3 is obtained, and it is possible to suppress the center pillar 3 from breaking and to suppress the center pillar 3 from entering the vehicle cabin. Furthermore, since the center pillar 3 has a structure of a closed cross section including the first winding layer 31a and the second winding layer 31b around the center pillar 3, even when a collision load is input at the time of a side collision, breakage starting from a joint or the like is suppressed, and it is possible to suppress breakage of the center pillar 3 or entry of the center pillar 3 into the vehicle cabin.

In the second region 3b of the pillar structure portion 21, the first tubular portion 25a and the second tubular portion 25b are provided so as to be separated from each other. A belt retractor 29, which is a seat belt winding device, can be disposed in a space 27 between the first tubular portion 25a and the second tubular portion 25b (see FIG. 3). In a case where the pillar structure portion is constituted by one tubular portion, it is necessary to provide an opening for arranging the belt retractor, but by arranging the belt retractor 29 in the space 27 between the first tubular portion 25a and the second tubular portion 25b, it is not necessary to provide such an opening. For this reason, it is possible to reduce the number of manufacturing processes and to prevent a decrease in strength due to the fibers being cut. In addition, since the first connecting member 14 is formed of a molded product made of a metal material, the belt retractor 29 can be protected at the time of a side collision.

Next, an example of a method of manufacturing the pillar structure portion 21 will be briefly described.

FIGS. 7 to 9 are explanatory views illustrating a method of manufacturing the pillar structure portion 21.

First, as illustrated in FIG. 7, the first tubular portion 25a and the second tubular portion 25b made of fiber-reinforced resin are formed by a known braiding method or winding method. For example, by a braiding method or a winding method, axial fibers are arranged and cross fibers are wound around a forming die for each of the first tubular portion 25a and the second tubular portion 25b, and these continuous fibers are cured by using matrix resins, thereby forming the inner tubular portions 33a and 33b.

Next, the metal plates 35a and 35b and the reinforcing layers 37a and 37b are arranged at predetermined positions of the inner tubular portions 33a and 33b, and further, axial fibers are arranged and cross fibers are wound by a braiding method or a filament winding method, and these continuous fibers are cured using matrix resins, thereby forming the outer tubular portions 34a and 34b.

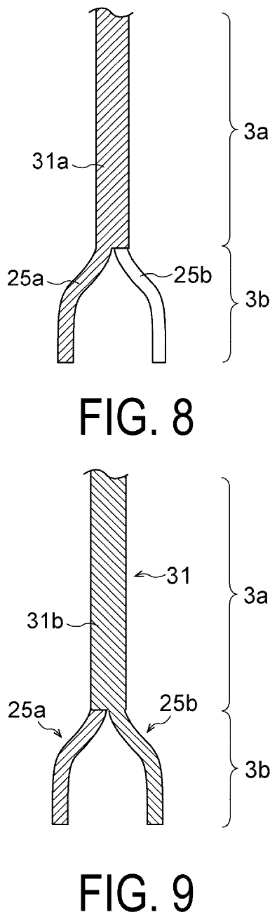

Next, as illustrated in FIG. 8, the first tubular portion 25a and the second tubular portion 25b are joined to each other at a portion corresponding to the first region 3a, and the axial fibers are arranged and the cross fibers are wound around the first region 3a and the first tubular portion 25a of the second region 3b by the braiding method or the filament winding method to form the first winding layer 31a.

Next, as illustrated in FIG. 9, by the braiding method or the filament winding method, the axial fibers are arranged and the cross fibers are wound around the first region 3a and the second tubular portion 25b of the second region 3b to form the second winding layer 31b. Then, the pillar structure portion 21 can be manufactured by curing the first winding layer 31a and the second winding layer 31b using the matrix resins. The second winding layer 31b may be formed and cured after the first winding layer 31a is cured using the matrix resins.

In this manner, it is possible to efficiently manufacture the pillar structure portion 21 made of the fiber-reinforced resin composite material containing continuous fibers, which includes the first tubular portion 25a and the second tubular portion 25b continuously formed from the upper portion to the lower portion in the longitudinal direction of the center pillar 3, and in which the layer thickness of the wall portion of the first region 3a on the upper side is relatively thicker than the layer thickness of the wall portion of the second region 3b on the lower side.

An embodiment of the technology of the present disclosure have been described in detail above with reference to the accompanying drawings, but the technology of the present disclosure is not limited to such examples. It will be apparent to those skilled in the art that various modifications and variations can be made without departing from the spirit or scope of the disclosure as defined by the appended aspects and their equivalents. In addition, an aspect in which the above-described embodiment and modifications are combined with each other also naturally belongs to the technical scope of the present disclosure.

For example, in the above-described embodiment, the center pillar has been described as an example of the vehicle body pillar structure, but the technology of the present disclosure may be applied to a front pillar or a rear pillar.

As described above, according to the technique of the present disclosure, it is possible to provide a vehicle body pillar structure capable of suppressing a decrease in the strength of a pillar when the pillar of a vehicle body is formed using a fiber-reinforced resin composite material.

1. A vehicle body pillar structure using a fiber-reinforced resin composite material, the vehicle body pillar structure comprising
two tubular portions made of a fiber-reinforced resin and arranged side by side in a vehicle body front-rear direction of a vehicle, each of the two tubular portions extending in a direction of an axis along a vehicle body height direction of the vehicle, wherein
the vehicle body pillar structure has
a first region where the two tubular portions are joined to each other on an upper side in the vehicle body height direction; and
a second region where the two tubular portions diverge and are spaced apart from each other on a lower side in the vehicle body height direction, and
each of the two tubular portions includes a metal plate provided over the first region and the second region.

2. The vehicle body pillar structure according to claim 1, wherein
each of end portions of the two tubular portions on the second region side is fitted to a fitting portion provided in a side sill of the vehicle, and the metal plate is fastened to the fitting portion by a fastening member.

3. A vehicle body pillar structure using a fiber-reinforced resin composite material, the vehicle body pillar structure comprising
two tubular portions made of a fiber-reinforced resin and arranged side by side in a vehicle body front-rear direction of a vehicle, each of the two tubular portions extending in a direction of an axis along a vehicle body height direction of the vehicle, wherein the vehicle body pillar structure has
a first region where the two tubular portions are joined to each other on an upper side in the vehicle body height direction; and
a second region where the two tubular portions diverge and are spaced apart from each other on a lower side in the vehicle body height direction,
the vehicle body pillar structure further comprises, in the first region, a first winding layer and a second winding layer comprising a continuous fiber wound around the two tubular portions and around the axis,
the first winding layer is provided from the first region to a first tubular portion of the two tubular portions in the second region, and
the second winding layer is provided from the first region to a second tubular portion of the two tubular portions other than the first tubular portion in the second region.

4. The vehicle body pillar structure according to claim 3, wherein
the first winding layer and the second winding layer are provided at least in a region of the first region, the region corresponding to a window shoulder portion of a side window of the vehicle.

5. A vehicle body side structure using a fiber-reinforced resin composite material, the vehicle body side structure comprising:
a center pillar comprising
two tubular portions made of a fiber-reinforced resin and arranged side by side in a vehicle body front-rear direction of a vehicle, each of the two tubular portions extending in a direction of an axis along a vehicle body height direction of the vehicle, the center pillar having:
a first region where the two tubular portions are joined to each other on an upper side in the vehicle body height direction; and
a second region where the two tubular portions diverge and are spaced apart from each other on a lower side in the vehicle body height direction, and
a side sill disposed along the vehicle body front-rear direction and coupled to a lower portion of the center pillar, wherein
a belt retractor is disposed in a space between the two tubular portions in the second region, and
each of the two tubular portions includes a metal plate provided over the first region and the second region.

6. A vehicle body side structure using a fiber-reinforced resin composite material, the vehicle body side structure comprising:
a center pillar comprising
two tubular portions made of a fiber-reinforced resin and arranged side by side in a vehicle body front-rear direction of a vehicle, each of the two tubular portions extending in a direction of an axis along a vehicle body height direction of the vehicle, the center pillar having:
a first region where the two tubular portions are joined to each other on an upper side in the vehicle body height direction; and
a second region where the two tubular portions diverge and are spaced apart from each other on a lower side in the vehicle body height direction, and
a side sill disposed along the vehicle body front-rear direction and coupled to a lower portion of the center pillar, wherein
a belt retractor is disposed in a space between the two tubular portions in the second region,
the vehicle body side structure further comprises, in the first region, a first winding layer and a second winding layer, the first winding layer and the second winding layer each comprising a continuous fiber wound around the two tubular portions and around the axis,
the first winding layer is provided from the first region to a first tubular portion of the two tubular portions in the second region, and
the second winding layer is provided from the first region to a second tubular portion of the two tubular portions other than the first tubular portion in the second region.
